(19) United States
(12) Patent Application Publication
(10) Pub. No.: US 2011/0069578 A1
(43) Pub. Date: Mar. 24, 2011

(54) BEVERAGE VENDING MACHINE MIXER

(75) Inventor: Dan Alexie Sirbu Villa, Bonate Sotto (IT)

(73) Assignee: N & W GLOBAL VENDING S.P.A., Valbrembo (Bergamo) (IT)

(21) Appl. No.: 12/867,484

(22) PCT Filed: Feb. 12, 2009
(86) PCT No.: PCT/IB09/00244

§ 371 Date: Nov. 30, 2010

(30) Foreign Application Priority Data
Feb. 13, 2008 (IT) TO2008A000110

(51) Int. Cl. B01F 15/02; B67D 7/74

(52) U.S. Cl. 366/131; 222/145.6; 366/164.6; 366/196

(57) ABSTRACT

A mixer (1) for a beverage vending machine (2), wherein the mixer (1) has a blender (22) in turn having an impeller (21) housed inside a blending chamber (11) and fitted removably to a drive shaft (23) to rotate about an axis (24); the drive shaft (23) having an end portion (26) in turn having two parallel flat faces (27) on opposite sides of the axis (24); the impeller (21) having a hub (30) in turn having at least two substantially rectangular-section seats (41) coaxial with each other and with the axis (24), and each designed to receive the end portion (26) of the drive shaft (23) in sliding and angularly fixed manner,—and one of the two seats (41) being engaged by the end portion (26) of the drive shaft (23).

### TECHNICAL FIELD

The present invention relates to a beverage vending machine mixer.

### BACKGROUND ART

A beverage vending machine mixer normally comprises a hollow body with a mixing chamber inside, to which soluble material and water are fed through respective inlets. Downstream from the mixing chamber, the hollow body has a blending chamber that communicates with the mixing chamber and with a beverage outflow conduit, and houses a blending device normally comprising an impeller connected angularly to the output shaft of an electric motor. To enable thorough cleaning of the mixer by the operator, the impeller is normally connected removably the shaft.

Known systems currently used to connect the impeller removably to the shaft have the drawback of normally being fairly complicated in terms of assembly, which may often call for considerable accuracy on the part of the operator. The problem is obviously also further compounded by the mixer having to be cleaned relatively frequently, and often being located in a poorly illuminated part of the machine that is hard to reach.

### DISCLOSURE OF INVENTION

It is an object of the present invention to provide a beverage vending machine mixer of the type described above, that is cheap and easy to produce and at the same time designed to eliminate the above drawbacks.

According to the present invention, there is provided a beverage vending machine mixer as claimed in claim 1 and preferably in any one of the Claims depending directly or indirectly on claim 1.

### BRIEF DESCRIPTION OF THE DRAWINGS

A non-limiting embodiment of the present invention will be described by way of example with reference to the accompanying drawings, in which:

FIG. 1 shows a section, with parts removed for clarity, of a preferred embodiment of the mixer according to the present invention;

FIG. 2 shows a larger-scale view in perspective of a detail in FIG. 1;

FIGS. 3 and 4 show a side view and front view respectively of a detail in FIG. 2;

FIG. 5 shows a section along line V-V in FIG. 4;

FIG. 6 shows an exploded view of a detail in FIG. 4 in two alternative configurations;

FIGS. 7 and 8 show sections along lines VII-VII and VIII-VIII in FIG. 6 respectively;

FIG. 9 shows a rear view of FIG. 6.

### BEST MODE FOR CARRYING OUT THE INVENTION

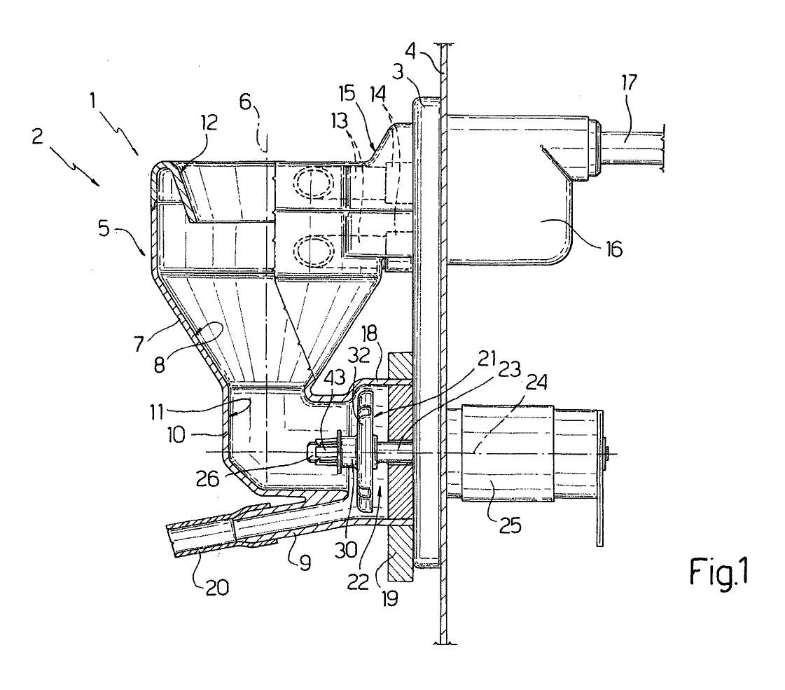

Number 1 in FIG. 1 indicates as a whole a mixer for a beverage vending machine 2.

Mixer 1 comprises a support 3 defined by a plate connected to a fixed wall 4 of machine 2 and facing a door (not shown) of machine 2.

Mixer 1 also comprises a hollow mixing body 5 having a substantially vertical axis 6 and in turn comprising a top portion 7 defining a mixing chamber 8; a bottom beverage outflow conduit 9; and an intermediate portion 10 interposed between top portion 7 and outflow conduit 9, an internally defining a blending chamber 11.

More specifically, as shown in FIG. 1, top portion 7 is funnel-shaped with a top inlet 12 coaxial with axis 6 and normally positioned facing one or more known spouts (not shown) to receive metered quantities of soluble material from one or more known tanks (not shown).

Close to inlet 12, top portion 7 has two water inlets defined by the outlets of two conduits 13 connected rigidly to top portion 7 and connected, by respective tubular fittings 14 integral with support 3, to the delivery side of a known pump (not shown) to simultaneously or selectively feed water into mixing chamber 8.

Just above conduits 13 and the free edge of inlet 12, a steam suction opening 15 defines the outlet of a condensation cell (not shown in FIG. 1) housed inside a pocket 16 of support 3 and connected to a suction circuit 17.

With reference to FIG. 1, intermediate portion 10 is defined by an elbow-shaped member integral with top portion 7 and defining blending chamber 11. At its free end facing support 3, intermediate portion 10 comprises a cylindrical portion 18 connected to support 3 by a removable joint 19 and defining at the bottom the inlet of outlet conduit 9, which extends frontwards of mixer 1 from cylindrical portion 18, and is fitted with an outflow hose 20.

Cylindrical portion 18 also defines a seat for an impeller 21 of a blender 22, which serves to stir the mixture of soluble material and water from mixing chamber 8 to fully dissolve the material and supply a homogeneous beverage to outflow conduit 9.

Impeller 21 is connected removably—as described in detail below—to a drive shaft 23, which has an axis of rotation 24 perpendicular to wall 4, extends inside blending chamber 11, and defines the output of an electric motor 25 forming part of blender 22 and fitted to the opposite side of wall 4 from mixer 1.

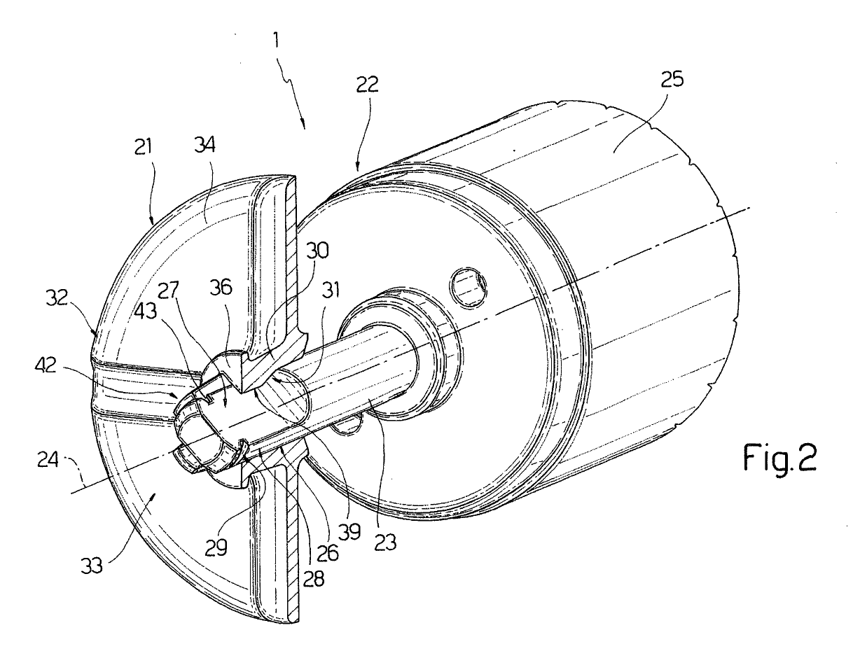

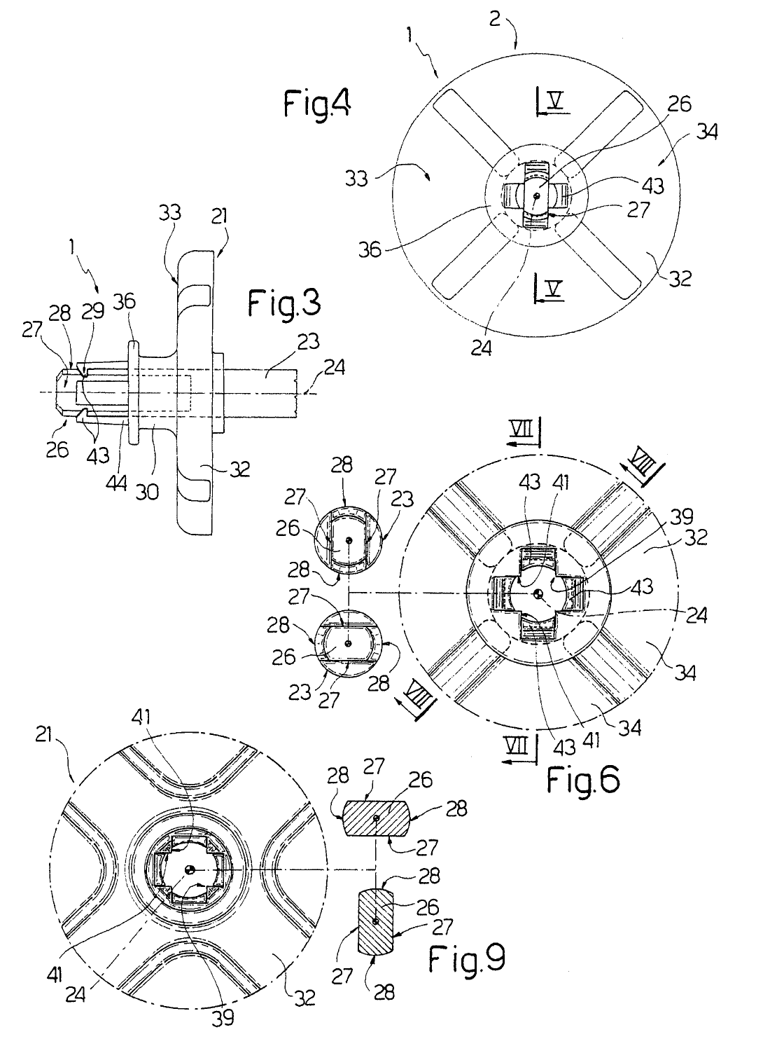

As shown in FIGS. 2, 3, 7 and 8, drive shaft 23 comprises a free-end portion 26 bounded laterally by two flat parallel faces 27 on opposite sides of axis 24, and by two cylindrical faces 28, which are coaxial with axis 24, connect flat faces 27, and each have a respective groove 29 lying, together with the other groove 29, in a plane perpendicular to axis 24.

As shown in FIGS. 2 to 6, impeller 21 comprises a central hub 30, which has a through hole 31 engaged by end portion 26 of drive shaft 23, and a disk 32 integral with hub 30 and bounded, on the side facing blending chamber 11, by a flat annular surface 33 having a rounded free edge, and four radial grooves equally spaced about axis 24 to define four flat blades 34 on annular surface 33.

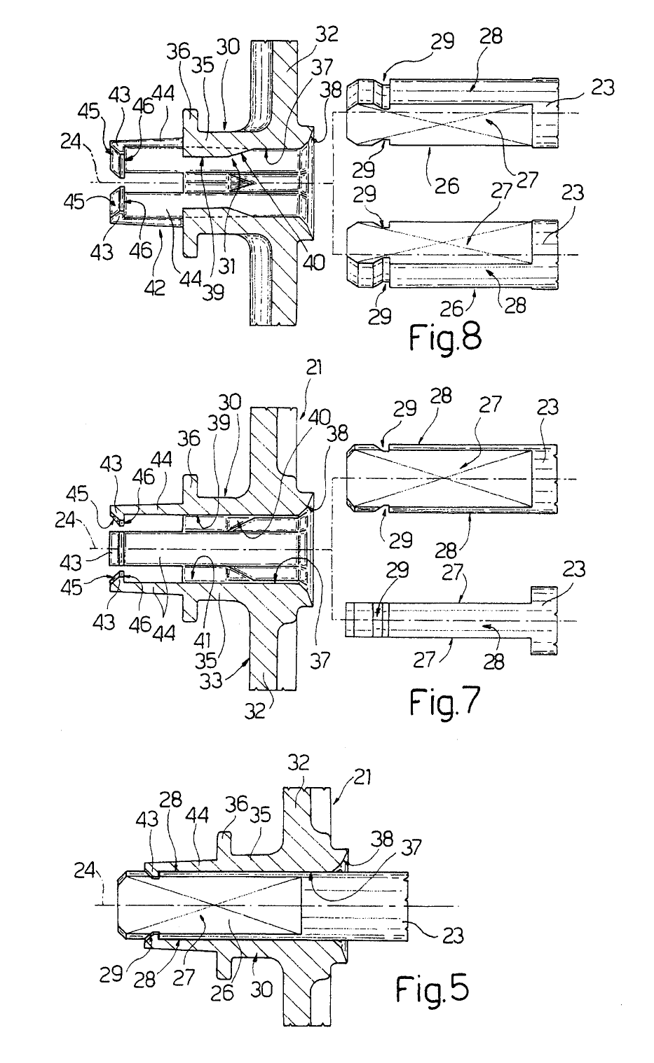

As shown in FIGS. 7 and 8, hub 30 comprises a front portion 35 that projects axially from annular surface 33 towards blending chamber 11, and is fitted on its free end with a circular flange 36 that projects radially outwards from front portion 35 and defines, in use, a user grip by which to grip impeller 21 to detach and refit it from and to drive shaft 23.

With reference to FIGS. 7 to 9, hole 31 comprises a cylindrical inlet hole 37 coaxial with axis 24 and having a truncated-cone-shaped lead-in flare 38 for end portion 26; and a cross-shaped hole 39 which is coaxial with axis 24, is connected to cylindrical hole 37 by a truncated-cone-shaped portion 40, and defines two rectangular-section seats 41 coaxial with each other and with axis 24, and each designed to receive end portion of drive shaft 23 in sliding and angularly fixed manner.

To lock hub 30 axially onto drive shaft 23, impeller 21 comprises a click-on retaining device 42 comprising four teeth 43, which are carried by flange 36 and each associated with a respective end of a respective seat 41, so that, when impeller 21 is fitted onto drive shaft 23, the teeth 43 associated with the seat 41 engaged by end portion 26 click into grooves 29. For this purpose, as shown in FIGS. 5 to 9, teeth 43 face axis 24 and are each connected to the respective end of relative seat 41 by a respective elastically deformable rod 44 extending axially from flange 36 towards blending chamber 11.

As shown in FIG. 5, each tooth 43 has a trapezoidal cross section, and is bounded externally by a face 45 sloping with respect to axis 24 by an angle of less than 90°, and which, when tooth 43 engages respective groove 29, cooperates with a surface of groove 29 sloping at the same angle as face 45 and which, when impeller 21 is withdrawn axially from end portion 26 of drive shaft 23, serves to flex relative rod 44 outwards and assist radial withdrawal of tooth 43 from groove 29.

On the side facing flange 36, each tooth 43 is bounded by a face 46 perpendicular to axis 24, and which, when tooth 43 engages respective groove 29, cooperates with a corresponding surface of groove 29 defining a shoulder to axially arrest impeller 21.

To conclude, it should be pointed out that, when assembling impeller 21 onto end portion 26, cross-shaped hole 39 allows the operator to fit hub 30 onto end portion 26 quickly and easily.

That is, regardless of the initial angular position of seats 41 with respect to flat faces 27 of end portion 26, the operator is able to align one of the two seats 41 axially with flat faces 27 by rotating impeller 21 about axis 24 by an angle of always less than 90°.

In a variation not shown, cross-shaped hole 39 may be defined by more than two seats 41 coaxial with one another and with axis 24 and equally spaced about axis 24. This provides, when assembling impeller 21, for further reducing the angle by which hub 30 must be rotated by the operator to align a seat 41 axially with flat faces 27.

1. A mixer for a beverage vending machine the mixer comprising:
a blending chamber;
a blender comprising a drive shaft rotating about a longitudinal axis, and an impeller housed inside the blending chamber and fitted removably to the drive shaft to rotate about the axis;
wherein the drive shaft comprises an end portion having two lateral, parallel flat faces on opposite sides of the axis;
and wherein the impeller comprises a hub having at least two substantially rectangular-section seats coaxial with each other and with the axis, each of the seats being designed to receive the end portion of the drive shaft in sliding and angularly fixed manner and one of the two seats being engaged by the end portion of the drive shaft.

2. A mixer as claimed in claim 1, wherein the seats define between them a cross-shaped hole coaxial with the axis.

3. A mixer as claimed in claim 2, wherein the hub has a through hole coaxial with the axis; the through hole having a first and a second portion; the first portion being a truncated-cone-shaped lead-in portion, and the second portion being said cross-shaped hole.

4. A mixer as claimed in claim 3, wherein the through hole has a cylindrical inlet portion.

5. A mixer as claimed in claim 1, further comprising releasable retaining means for connecting the impeller in axially fixed manner to the drive shaft.

6. A mixer as claimed in claim 5, wherein the retaining means comprises a click-on retaining device.

7. A mixer as claimed in claim 1, wherein the end portion of the drive shaft comprises two connecting surfaces connecting the two flat faces; the connecting surfaces having respective grooves in a plane perpendicular to the axis; and further comprising a retaining device comprising a number of teeth carried by the impeller; each tooth being associated with a respective said seat, and extending from the hub at a respective end of the relative seat; and each tooth associated with the seat engaged by the end portion of the drive shaft engaging a respective said groove.

8. A mixer as claimed in claim 7, wherein the connecting surfaces are cylindrical surfaces coaxial with the axis.

9. A mixer as claimed in claim 7, wherein the hub comprises a number of elastically deformable, axial rods; each rod supporting on its free end a respective said tooth facing the axis.

10. A beverage vending machine comprising at least one mixer as claimed in claim 1.
